(19) United States
(12) Patent Application Publication
(10) Pub. No.: US 2005/0185967 A1
(43) Pub. Date: Aug. 25, 2005

(54) Optical repeating apparatus, optical network system, optical network design supporting apparatus and design supporting method

(75) Inventor: Takeshi Hoshida, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 11/111,874

(22) Filed: Apr. 22, 2005

Related U.S. Application Data
(63) Continuation of application No. PCT/JP03/06063, filed on May 15, 2003.

(51) Int. Cl. H04B 10/02

(52) U.S. Cl. 398/173

(57) ABSTRACT

The present invention relates to a technique suitable for the enhancement of efficiency of wavelength allocation in an optical network. A transmission capability for each of a plurality of wavelengths available in the optical network is calculated to allocate, to a recommendation optical transmission path in the optical network for a traffic demand from the external, a wavelength having a transmission capability corresponding to a total optics transmission distance of the recommendation optical transmission path on the basis of a result of the calculation. This enables considerably reducing the number of optical repeaters to be disposed, each of which has an electrical signal regeneration function in the optical network, thereby reducing the number of devices, dissipation power, installation area and others in the optical network.

### CROSS REFERENCE TO RELATED APPLICATIONS

This application is based on and hereby claims priority to PCT international application No. PCT/JP2003/006063 filed on May 15, 2003 in Japan, the contents of which are hereby incorporated by reference.

### BACKGROUND OF THE INVENTION

(1. ) Field of the Invention

The present invention relates to an optical repeating apparatus (optical repeater), optical network system, optical network design supporting apparatus and design supporting method, and more particularly to a technique suitable for use in the enhancement of efficiency of wavelength allocation.

(2. ) Description of Related Art

So far, there has been known an optical (photonic) network system realized by a combination of a wavelength multiplex (WDM: Wavelength Division Multiplex) transmission technique designed to achieve an increase in transmission capacity by transmitting two or more optical signals with different wavelengths through the same optical fiber in a multiplexed condition and a wavelength switching technique (including the so-called optical cross connect, wavelength cross connect, wavelength add/drop and others) designed to control an output path (route).

The biggest feature of such a photonic network system is that, in a case in which a service starts on the basis of a given plant and equipment investment at the start of the network service, a quick and economical transmission capacity enhancement becomes feasible by a small-scale additional investment against an successive increase in traffic demand.

Meanwhile, the photonic network systems are roughly classified into “opacity” type and “transparency” type. The former is designed to once convert all optical signals, arriving at a wavelength switch station, into electric signals, while the latter involves techniques other than it. Moreover, as the topology of the network system, there are at least a linear type, a ring type and a mesh type.

In addition, so far, as a technique for use in a transparent wavelength multiplex photonic network, there have been proposed techniques disclosed in the following documents.

[Non-Patent Document 1]

X. Jia et al., “A new wavelength assignment method for minimal wavelength conversions in WDM networks,” Proceedings. Ninth International Conference on Computer Communications and Networks, pp. 621-624, 2000.

[Non-Patent Document 2]

J. M. H. Elmirghani and H. T. Mouftah, “All-optical wavelength conversion: technologies and application in DWDM networks,” IEEE Communications Magazine Vol. 38, pp. 86-92, March 2000.

[Non-Patent Document 3]

M. Kovacevic and A. S. Acampora, “Electronic wavelength translation in optical networks,” J. Lightwave Technol., Vol. 14, pp. 1161-1169, June 1996.

[Patent Document 1]

Japanese Patent Laid-Open No. HEI 11-266207

[Patent Document 2]

Japanese Patent Laid-Open No. 2000-341250

[Patent Document 3]

Japanese Patent Laid-Open No. 2001-119734

[Patent Document 4]

Japanese Patent Laid-Open No. 2002-64435

The techniques proposed in the aforesaid non-patent documents 1 to 3 and patent document 3 relate to an algorithm for allocating a wavelength to a specified traffic request in a photonic network and entirely take notice of the setting of a wavelength path in consideration of a network layer and, in particular, deals with the wavelength allocation for the purpose of enhancing the wavelength utilization efficiency.

Moreover, the technique proposed in the aforesaid patent document 1 relates to an optical repeater having a function to, for enabling the long-distance transmission of an optical signal, after once converting all inputted optical signals into electric signals and further carrying out the electrical waveform regeneration (reproduction), again convert the signals waveform-regenerated into the optical signals before transmitting them. This technique has come into widespread use in the field of photonic network systems.

Still moreover, the technique proposed in the aforesaid patent document 4 relates to a technique for determining a route of an optical path and a wavelength to minimize the number of optical cross connect units with an expensive wavelength conversion function in a wavelength multiplex network. This technique is made to make a decision as to whether or not to carry out the wavelength conversion on all optical paths, in which nodes Nₙ (n denotes an integer of 1 to N) do not establish a starting point or an end point, in the node Nₙ and, if all the optical paths do not undergo the wavelength conversion, record a value Wₙ as 0 and, if at least one of all the optical paths undergoes the wavelength conversion, record the value Wₙ as 1 for selecting an route of an optical path so that, with respect to all the nodes N₁, N₂, . . . , Nₙ, the sum of N values W₁, W₂, . . . , Wₙ reaches a minimum, and for selecting a wavelength to be allocated to the optical path in each optical fiber transmission line.

Yet moreover, the technique proposed in the aforesaid patent document 2 relates to, in a WDM transmission system, the reduction of the influence of inter-wavelength crosstalk stemming from the four wave mixing (FWM) which is a cause of the degradation of transmission quality, and is a technique in which, in a node, two wavelengths, the wavelength interval of which is small in the vicinity of the zero dispersion wavelength, are allocated to a short transmission distance line while two wavelengths, the wavelength interval of which is large, are allocated to a long-transmission distance line.

According to this wavelength allocation, since the wavelengths existing at a large wavelength interval are assigned to a long-transmission distance line, the influence of the crosstalk due to the FWM is reducible while, although the wavelengths existing at a small wavelength interval are assigned to a short transmission distance line, the short transmission distance leads to the reduction of the influence of the crosstalk due to the FWM.

Meanwhile, in most cases, a wavelength dependency exists essentially in the transmission characteristic of an optical signal. For example, as shown in FIG. 15, a dispersion compensator (dispersion compensating fiber) for making a compensation for chromatic dispersion is made up of a dispersion slope (see reference numeral 101) having an optical transmission line (fiber) and a reverse dispersion slope (see reference numeral 102) and, when the dispersion slope compensation rate does not correspond to the dispersion slope and does not reach 100%, the complete dispersion compensation is feasible in terms of a specified wavelength [in general, a wavelength (which will hereinafter be referred to as a “central wavelength”) in the vicinity of the center of a WDM signal band], while a dispersion compensation error occurs in terms of the other wavelengths, which leads to the occurrence of a residual dispersion slope (see reference numeral 103).

Accordingly, with respect to a given transmission distance, there arises a phenomenon that light with a given wavelength [central wavelength (channel)] is receivable at all times whereas light with the other wavelengths (channels) are unreceivable at all times, so the transmission distance of the entire WDM signal is limited by the transmittable distance of the specified wavelength.

In particular, in the case of an optical transmission, for example, as illustratively shown in FIG. 14, due to the nonlinear optical effect [self phase modulation (SPM)/XPM (Cross Phase Modulation)], an allowable cumulative dispersion range (tolerance) 104 (this depends upon SPM, XPM, dispersion compensation rule and others and, if the residual dispersion exists in this range, the transmission is feasible in terms of dispersion), so-called cumulative dispersion limit, exists and this range becomes smaller according to the transmission distance, which causes the transmittable distance to encounter a different restriction for each wavelength due to the dispersion characteristic and the nonlinear effect.

For example, in FIG. 14, when the central wavelength is taken as λc, a wavelength on a shorter wavelength side relative to the central wavelength λc is taken as λs (<λc) and a wavelength on a longer wavelength side relative to the central wavelength λc is taken as λ_{L} (>λc), with respect to a light with the wavelength λs on the shorter wavelength side, the cumulative dispersion quantities after the transmissions in first and second transmission sections can fall in the cumulative dispersion limit 104 owing to the dispersion compensations in first and second dispersion compensators, but, after the transmission in the next transmission sections, they no longer fall in this limit 104 (see dotted line 105) and the transmission comes to an end at the first and second transmission sections (position indicated by reference numeral 108).

Likewise, with respect to a light with the wavelength λ_{L} on the longer wavelength side, the cumulative dispersion quantities after the transmissions in first to third transmission sections can fall in the cumulative dispersion limit 104 owing to the dispersion compensations in first to third dispersion compensators, but, after the transmission in the next transmission sections, they no longer fall in this limit 104 (see alternate long and short dash line 106) and the transmission comes to an end at the first and second transmission sections (position indicated by reference numeral 108).

On the other hand, with respect to the light with the central light λc, the cumulative dispersion quantity can fall in the cumulative dispersion limit 104 even after the transmissions in first to fourth transmission sections, so a longer-distance (until the position indicated by a reference numeral 109 in FIG. 14) transmission becomes feasible in comparison with the wavelength λs on the shorter wavelength side and the wavelength λ_{L} on the longer wavelength side. Thus, in general, as illustratively shown in FIG. 16, a light with a wavelength closer to the central wavelength λc can provide a longer transmittable distance.

In addition, as another case, no problem arises with the chromatic dispersion compensation, but the optical signal-to-noise ratio (OSNR) can affect the transmission distance limit. That is, for example, as illustratively shown in FIG. 17, in general, a light with a wavelength on a shorter wavelength side in a WDM signal band tends to have a poorer OSNR than a wavelength on a longer wavelength side in the WDM signal band and, hence, the transmittable distance becomes shorter.

Although this problem in the OSNR unevenness (wavelength dependency) is compensated for through the use of an optical pre-emphasis technique or the like, if the network configuration is a ring type, a mesh type or when an optical path becomes complicated because of including an OADM (Optical Add-Drop Multiplexer), a so-called optical cross connect unit or optical switch which is referred to as an optical hub, a wavelength converter and other devices, the optical pre-emphasis control becomes extremely complicated and the application thereof becomes difficult. Moreover, in this case, add to it that a problem arises in the wavelength dependency of the OSNR.

In a network design, at the allocation of a wavelength to an optical path (traffic), if the wavelength allocation is made in consideration of only the network layer with paying attention to the above-mentioned wavelength dependency of the transmission characteristic, the wavelength allocation becomes inefficient as a result and an excessive number of electrical signal regenerators (optical repeater including these devices) become necessary, which increases the network construction cost extremely. Incidentally, as disclosed in the patent document 1, the electrical signal regenerator is usually equipped with an optical-electrical (O/E) converter and an electrical-optical (E/O) converter (in some cases, further including a wavelength converter) to provide a function to, after received optical signals are once converted through the O/E converter into electric signals and regenerated in waveform, convert them through the E/O converter into optical signals before transmission. Thus, this results in a very expensive and large-scale apparatus.

However, nowhere in the above-mentioned non-patent documents 1 to 3 and the patent documents 1, 3 and 4 is there any method and apparatus configuration for carrying out the wavelength allocation to a traffic on a network in consideration of the wavelength dependency of the transmission characteristic. On the other hand, the above-mentioned patent document 2 discloses a technique of allocating wavelengths existing at a small wavelength interval in the vicinity of the zero dispersion wavelength to a short transmission distance line and assigning wavelengths existing at a large wavelength interval to a long transmission distance line. However, in this case, the “line” is considered as the concept on “required path” resulting from the route calculation on a traffic demand of a network.

From this, it is naturally considered that an electrical signal regenerator is required in the middle of the “required path”. In this situation, for carrying out the concrete wavelength allocation to a network in which a complicated path setting is feasible, it is required that a decision is made as to which of the sections of the “required path” is a section (distance) in which an optical signal is transmittable without conducting the electrical signal regeneration (electrical regenerative relay) (this section or distance is referred to as a “total optics transmission section” or “total optics transmission distance”) and the wavelength allocation is taken into consideration. However, the patent document 2 does not disclose this technique.

In addition, in the technique disclosed in the patent document 2, for the purpose of reducing the occurrence of crosstalk resulting from FWM, wavelengths existing at a long or short “wavelength interval” are allocated according to transmission distance of a line. That is, the wavelength allocation is not made in consideration of the fact that the transmission distance limit varies according to wavelength. For this reason, there is a possibility that the wavelength allocation is made in an inefficient manner and, depending on a wavelength allocation method, a signal regenerator, which is originally unnecessary, is required in a network design stage.

The present invention has been developed in consideration of the above-mentioned problems, and it is an object of the invention to, even in a complicated optical network configuration, realize efficient wavelength allocation while reducing the number of expensive and large-apparatus-scale signal regenerators to be installed in a possible measure.

### SUMMARY OF THE INVENTION

For achieving the above-mentioned purpose, an optical repeating apparatus according to the present invention comprises a regenerative repeating unit for selectively carrying out electrical regenerative relay on a plurality of inputted optical signals and a wavelength converter for selectively carrying out wavelength conversion on the optical signal which is an object of the electrical regenerative relay in the regenerative repeating unit and for converting the optical signal which is an object of the wavelength conversion into a wavelength pertaining to, of wavelength classes obtained by classification according to transmission capability, one of a wavelength class equal to a wavelength class, to which the wavelength before the wavelength conversion pertains, and a wavelength class different therefrom which is to be selected on the basis of a difference in total optics transmission distance between before and after the electrical regenerative relay.

In this case, it is also appropriate that the wavelength converter is configured so as to, in a case in which the total optics transmission distance after the electrical regenerative relay is longer than the total optics transmission distance before the electrical regenerative relay, convert the optical signal which is an object of the wavelength conversion into a wavelength pertaining to a wavelength class equal to the wavelength class to which the wavelength before the wavelength conversion pertains or a wavelength class higher than the wavelength class to which the wavelength before the wavelength conversion pertains, or that the wavelength converter is configured so as to, in a case in which the total optics transmission distance after the electrical regenerative relay is shorter than the total optics transmission distance before the electrical regenerative relay, convert the optical signal which is an object of the wavelength conversion into a wavelength pertaining to a wavelength class equal to the wavelength class to which the wavelength before the wavelength conversion pertains or a wavelength class lower than the wavelength class to which the wavelength before the wavelength conversion pertains.

In addition, it is also acceptable that the wavelength classes are classified so as to have a higher rank order or an equal rank order as the wavelength becomes longer, or to have a higher rank order or an equal rank order as the wavelength classes are closer to a reference wavelength defined in a transmission wavelength band of the plurality of inputted optical signals.

Moreover, an optical network system according to the present invention is equipped with the optical repeating apparatus having the above-mentioned features.

Furthermore, an optical network design supporting apparatus for use in according to the present invention, which is made to selectively dispose one or more optical repeating apparatuses each having a function for selectively carrying out electrical regenerative relay on a plurality of inputted optical signals and a function for selectively carrying out wavelength conversion on the optical signal which is an object of the electrical regenerative relay, the design supporting apparatus comprising storage means for storing wavelength class information on wavelength classes obtained by classification of a plurality of wavelengths available in the optical network according to transmission capability of the wavelengths, recommendation transmission path dividing means for, in a case in which an idle wavelength which satisfies optical transmission over a total optics transmission distance of a recommendation optical transmission path in the optical network for a traffic demand from the external does not exist among the available wavelengths, dividing the recommendation optical transmission path into a plurality of optical transmission sections by the disposition of the optical repeating apparatus, and wavelength allocating means for allocating a wavelength pertaining to, of the wavelength classes obtained by the classification based on the wavelength class information in the storage means, one of a wavelength class equal to a wavelength class, to which a wavelength before the wavelength conversion of the optical signal pertains, and a wavelength class different therefrom which is to be selected on the basis of a difference in total optics transmission distance of the optical transmission section between before and after the electrical regenerative relay.

In this case, it is also appropriate that the wavelength allocating means is configured so as to, in a case in which the total optics transmission distance of the optical transmission section after the electrical regenerative relay in the optical repeating apparatus is longer than the total optics transmission distance of the optical transmission section before the electrical regenerative relay, allocate a wavelength pertaining to a wavelength class equal to the wavelength class to which the wavelength before the wavelength conversion in the optical repeating apparatus pertains or a wavelength class higher than the wavelength class to which the wavelength before the wavelength conversion pertains, while, in a case in which the total optics transmission distance of the optical transmission section after the electrical regenerative relay in the optical repeating apparatus is shorter than the total optics transmission distance of the optical transmission section before the electrical regenerative relay, allocate a wavelength pertaining to a wavelength class equal to the wavelength class to which the wavelength before the wavelength conversion in the optical repeating apparatus pertains or a wavelength class lower than the wavelength class to which the wavelength before the wavelength conversion pertains.

In addition, an optical network design supporting method for use in according to the present invention, which is for selectively disposing one or more optical repeating apparatuses each having a function to selectively carry out electrical regenerative relay on a plurality of inputted optical signals and a function to selectively carry out wavelength conversion on the optical signal which is an object of the electrical regenerative relay, the design supporting method comprising the steps of storing, in storage means, wavelength class information on wavelength classes obtained by classification of a plurality of wavelengths available in the optical network according to transmission capability of the wavelengths, in a case in which an idle wavelength which satisfies optical transmission over a total optics transmission distance of a recommendation optical transmission path in the optical network for a traffic demand from the external does not exist among the available wavelengths of the wavelength class information in the storage means, dividing the recommendation optical transmission path into a plurality of optical transmission sections by the disposition of the optical repeating apparatus, and, with respect to the optical signal which is an object of the wavelength conversion in the optical repeating apparatus, allocating a wavelength pertaining to, of the wavelength classes obtained by the classification based on the wavelength class information in the storage means, one of a wavelength class equal to a wavelength class, to which a wavelength before the wavelength conversion of the optical signal pertains, and a wavelength class different therefrom which is to be selected on the basis of a difference in total optics transmission distance of the divided optical transmission section between before and after the electrical regenerative relay.

In this case, it is also appropriate that a comparison is made in terms of the total optics transmission distances of the divided optical transmission sections and, in a case in which the total optics transmission distance of the optical transmission section after the electrical regenerative relay in the optical repeating apparatus is longer than the total optics transmission distance of the optical transmission section before the electrical regenerative relay, a wavelength pertaining to a wavelength class equal to the wavelength class to which the wavelength before the wavelength conversion in the optical repeating apparatus pertains or a wavelength class higher than the wavelength class to which the wavelength before the wavelength conversion pertains is allocated as a wavelength of the optical signal after the wavelength conversion and, in a case in which the total optics transmission distance of the optical transmission section after the electrical regenerative relay in the optical repeating apparatus is shorter than the total optics transmission distance of the optical transmission section before the electrical regenerative relay, a wavelength pertaining to a wavelength class equal to the wavelength class to which the wavelength before the wavelength conversion in the optical repeating apparatus pertains or a wavelength class lower than the wavelength class to which the wavelength before the wavelength conversion pertains is allocated as the wavelength of the optical signal after the wavelength conversion.

Moreover, a design supporting apparatus for use in an optical network according to the present invention comprises transmission capability calculating means for calculating a transmission capability for each of a plurality of wavelengths available in the optical network, and wavelength allocating means for allocating, to a recommendation optical transmission path in the optical network for a traffic demand from the external, a wavelength having a transmission capability corresponding to a total optics transmission distance thereof on the basis of a result of the calculation in the transmission capability calculating means.

Still moreover, a design supporting method for use in an optical network according to the present invention comprises the steps of calculating a transmission capability for each of a plurality of wavelengths available in the optical network, and allocating, to a recommendation optical transmission path in the optical network for a traffic demand from the external, a wavelength having a transmission capability corresponding to a total optics transmission distance thereof on the basis of a result of the calculation.

### BRIEF DESCRIPTION OF THE DRAWINGS

FIG. 1 is a block diagram showing a configuration of a photonic (WDM) network system according to an embodiment of the present invention;

FIG. 2 is a block diagram showing a configuration of a node equipment (NE) functioning as an optical repeater (electrical regenerative repeater) shown in FIG. 1;

FIG. 3 is a block diagram showing a configuration of a node equipment (NE) functioning as a cross connect device shown in FIG. 1;

FIG. 4 is a block diagram showing a configuration of an essential part of a network design/control supporting apparatus shown in FIG. 1;

FIG. 5 is an illustrative view showing a configuration of a mesh type photonic network according to this embodiment;

FIG. 6 is a flow chart useful for explaining an operation (wavelength allocation) of the network design/control supporting apparatus shown in FIGS. 1 and 4;

FIGS. 7 and 8 are illustrative views partially showing a photonic network for the operation of the network design/control supporting apparatus shown in FIGS. 1 and 4;

FIG. 9 is an illustration useful for explaining the definition of wavelength class information for use in the network design/control supporting apparatus shown in FIGS. 1 and 4;

FIGS. 10, 11, 12 and 13 are illustrations of examples of wavelength allocation results by the network design/control supporting apparatus shown in FIGS. 1 and 4;

FIG. 14 is an illustrative view useful for explaining a transmission distance limit of a wavelength stemming from dispersion in optical transmission;

FIG. 15 is an illustration of examples of a dispersion slope due to a dispersion compensating fiber and a residual dispersion slope after dispersion compensation;

FIG. 16 is an illustration of one example of a transmission distance limit for each wavelength stemming from chromatic dispersion; and

FIG. 17 is an illustration of one example of a transmission distance limit for each wavelength stemming from OSNR.

### DESCRIPTION OF THE PREFERED EMBODIMENTS

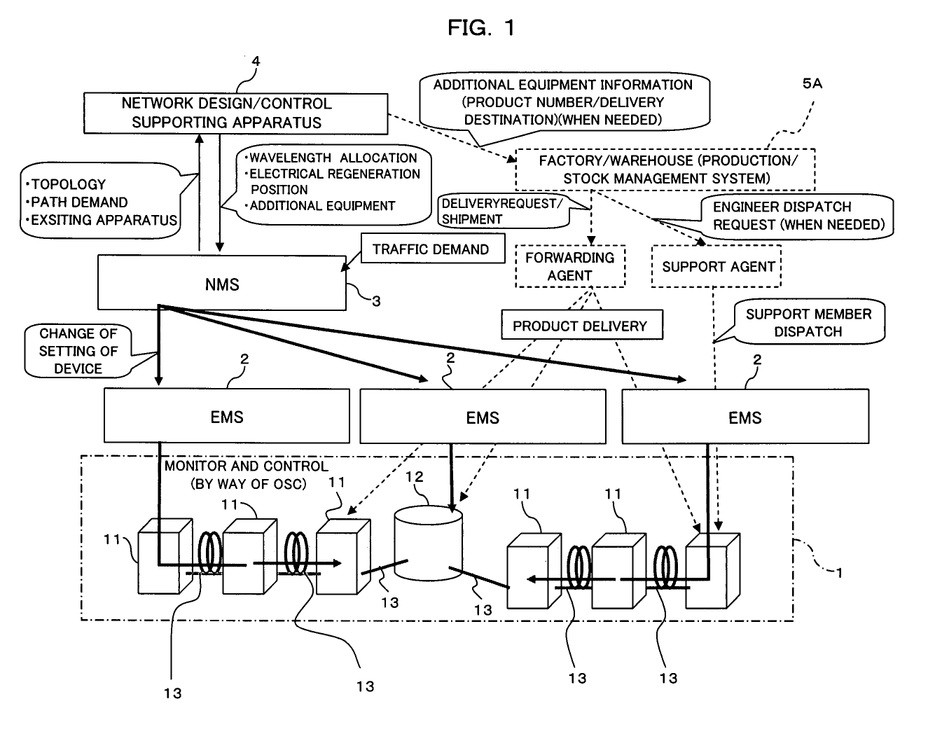

FIG. 1 is a block diagram showing a configuration of a photonic (WDM) network system according to an embodiment of the present invention. The photonic network system (which hereinafter will be equally referred to simply as a “system”) is made up of a photonic network 1, a node management apparatus (EMS: Element Management System) 2, a network management apparatus (NMS: Network Management System) 3, a network design/control supporting apparatus 4, and others. In this embodiment, the photonic network 1 is based upon a transparence type network.

In this configuration, the photonic network 1 includes, as components (NE: Network Elements), various types of node equipment, the number of which is determined properly, such as WDM transmission apparatus 11 and optical cross connect unit (OXC) and is configured in a state where these components are connected through optical transmission lines (optical fibers) 13 to each other.

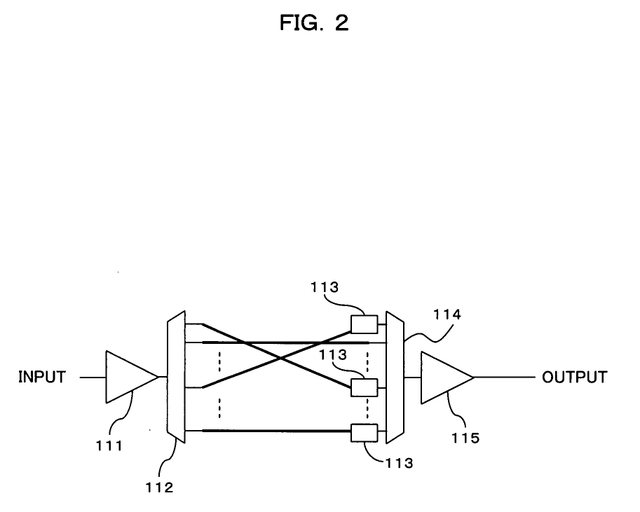

In addition, as shown in FIG. 2, of these NEs, an NE functioning as an optical repeater (electrical regenerative repeater) is equipped with optical amplifiers 111 and 115 such as EDFAs which are made to collectively amplify a WDM signal in terms of wavelengths, a wavelength demultiplexer 112 for demultiplexing a WDM signal for each wavelength, electrical signal regenerators 113 each provided for each wavelength and having a function to once convert the respective optical signals (channel signals) after the wavelength demultiplexing into electric signals for waveform regeneration and then to again convert them into optical signals (at this time, carrying out wavelength conversion when needed), and a wavelength multiplexer 114 for multiplexing the respective channel signals into a WDM signal.

In this connection, the electrical regenerative relay (repeating) can also be selectively conducted on a plurality of inputted optical signals through the setting of each of the electrical signal regenerators 113. That is, each of the electrical signal regenerators 113 functions as a regenerative repeating unit to selectively carry out the electrical regenerative relay on the plurality of inputted optical signals.

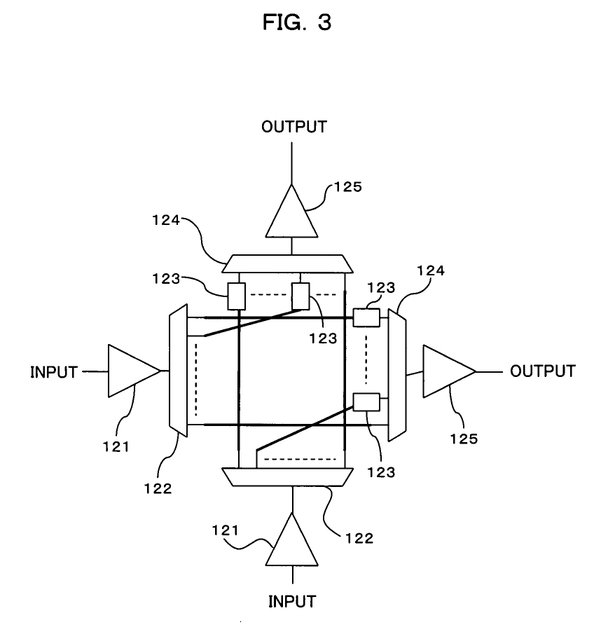

On the other hand, for example, as shown in FIG. 3, an NE functioning as OXC is equipped with a set comprising an optical amplifier 121 and a wavelength demultiplexer 122, which are similar to those mentioned above, for each input port, a set comprising a wavelength multiplexer 124 and an optical amplifier 125, which are similar to those mentioned above, for each output port, and electrical signal regenerators 123, which are similar to those mentioned above, provided between the wavelength demultiplexer 122 and the wavelength multiplexer 124.

Moreover, the EMS 2 is for individually carrying out the maintenance/operation management (monitor control) on nodes 11 and 12 each forming a component of the photonic network 1 in units of node, and NMS 3 is for intensively carrying out the monitor control (including the setting such as wavelength allocation and others) on the entire photonic network (which hereinafter will equally be referred to simply as a “network”) 1 by implementing the intensive management on the EMS 2. The information for the monitor control is usually interchanged between nodes through the use of a wavelength [which is referred to as OSC (Optical Supervisory Channel)] allocated for the monitor control.

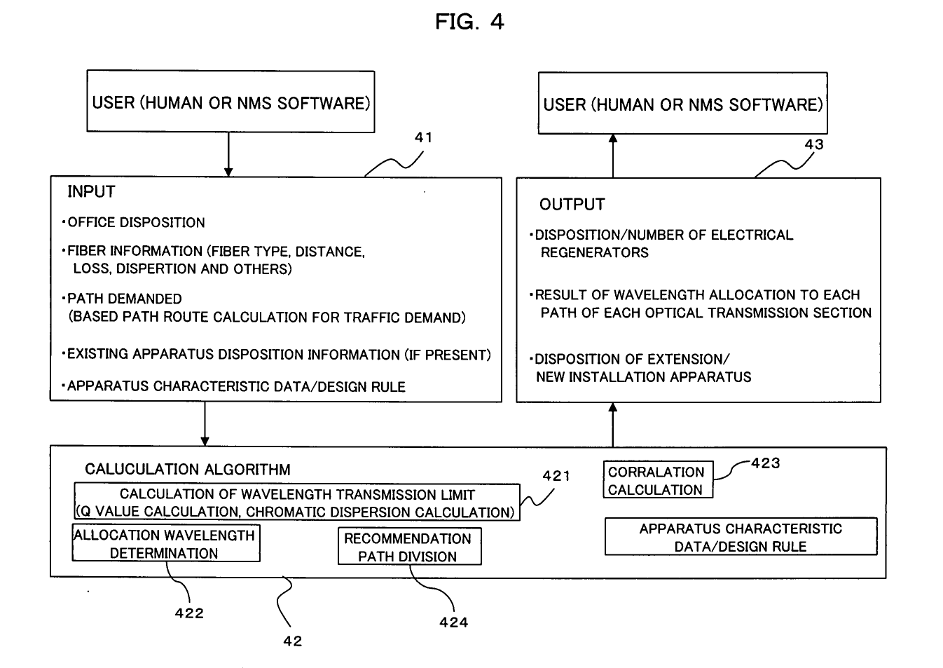

The network design/control supporting apparatus (which hereinafter will equally be referred to simply as a “supporting apparatus”) 4 is made to establish communications with the NMS 3 for supporting the design (information construction, such as positions of disposition of nodes, number of nodes to be disposed and wavelength allocations) and control of the photonic network 1 and, for example, it is constructed with a computer such as personal computer. Concretely, for example, as shown in FIG. 4, it is composed of an input unit 41, a calculation unit 42, and an output unit 43. The functions thereof in the supporting apparatus 4 can also be mounted as a portion of the functions of the NMS 3.

The input unit 41 is for accepting the input of various types of information [for example, network topology (office placement information, existing apparatus disposition information and others), fiber information (type of fiber, distance thereof, loss, dispersion and others), path demand information (information obtained through path route calculation based on a traffic demand), apparatus characteristic data, design rule, and other information] needed for the network design/control and given from the NMS 3 (or an operator).

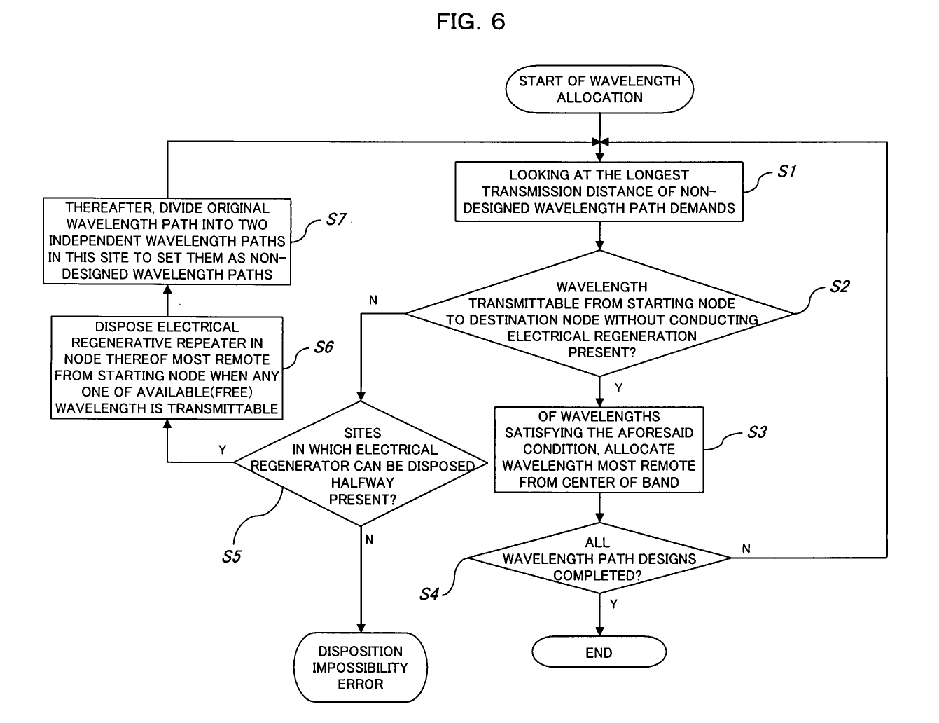

The calculation unit (wavelength allocating unit) 42 has a function as a wavelength transmission limit calculating unit (transmission capability calculating unit) 421 to determine a recommendation optical transmission path (recommendation path) for a path demand on the basis of information inputted through the aforesaid input unit 41 according to an algorithm which will be mentioned later with reference to FIG. 6 and further has a function as a wavelength determining unit 422 to determine a wavelength (recommendation allocation wavelength) suitable for the allocation to the aforesaid determined recommendation path on the basis of a result of the calculation.

Although this calculation unit 42 further has functions as a correlation calculating unit 423 and a recommendation path dividing unit 424, these functions will be mentioned later. Moreover, in addition to the determination of the recommendation allocation wavelength, this calculation unit 42 also has a function to determine the needed number and disposition positions of electrical signal regenerators 113 (123), disposition of needed extension/new installation (additional equipment), or the like.

The output unit 43 is for supplying the results (the wavelength allocation result, the needed number and disposition positions of the electrical signal regenerators 113 (123), the disposition of needed additional equipment, or the like) acquired as mentioned above in the calculation unit 42 to the NMS 3 (or an operator). Incidentally, the aforesaid additional equipment information (for example, product number, delivery destination or the like) can also be given to a terminal (production/stock management system) 5A located in a factory, warehouse or the like for the apparatus constituting the photonic network 1. Upon receipt of the aforesaid additional equipment information from the supporting apparatus 4, the production stock management system 5A can make a delivery request to a forwarding agent for parts or the like needed for the additional equipment or a dispatch request to a support agent for engineers when needed.

A detailed description will be given hereinbelow of an operation (in particular, a network design procedure in the supporting apparatus 4) of the photonic network system according to this embodiment thus configured.

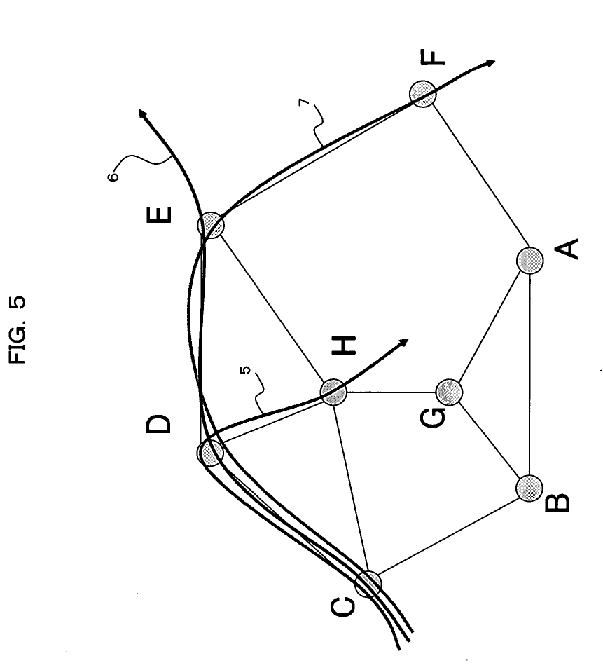

First of all, for example, in a network 1 in which nodes A, B, C, D, E, F, G and H are connected in a mesh-like configuration as shown in FIG. 5, looking at three paths: a path 5 of node C→node D→node H, a path 6 of node C →node D→node E and a path 7 of node C→node D→node E→node F.

In this case, the light in each of the three paths 5, 6 and 7 is transmitted through the same fiber in a transmission section of node C-node D and, hence, difficulty is experienced in allocating the same wavelength. For this reason, the supporting apparatus 4 first allocates a wavelength existing at the center of a WDM signal band, which has the highest transmission capability (longest transmittable distance), to the path 7 having the longest transmission distance and then allocates a wavelength having the next highest transmission capability to the path 6 having the next longest transmission distance and, likewise, allocates a wavelength, which is next in transmission capability, to the path 5 having the shortest transmission distance.

When the wavelength allocation is made according to this allocation rule, there is a tendency that a wavelength having a higher transmission capability is allocated to a path having a longer total optics transmission distance (which signifies a transmittable distance in a state where the light is maintained intact without conducting electrical signal regeneration), while a wavelength having a lower transmission capability is allocated to a path having a shorter total optics transmission distance.

Referring to the flow chart of FIG. 6 (algorithm), a description will be given hereinbelow of this wavelength allocation procedure.

First, in response to a path demand for a non-designed (non-allocated) wavelength, the supporting apparatus 4 (calculation unit 42) looks at a path (the path 7 in the case shown in FIG. 5) having the longest transmission distance in the network 1 (step S1) and confirms whether or not there exists a available wavelength (idle wavelength) having a transmission capability whereby the transmission from the starting node of this path to the destination node thereof is possible without conducting the electrical signal regeneration (step S2). Let it be assumed that the transmission capability of each of the wavelengths available in a WDM signal band (which hereinafter will equally be referred to simply as a “band”) has already been calculated in the calculating unit 42 (wavelength transmission limit calculating unit 421). Moreover, let it be assumed that the supporting apparatus 4 is naturally made to successively manage the allocated wavelengths and the non-used wavelengths in the band.

In consequence, in a case in which the available wavelengths existing therein are one or more in number (YES in step S2), if the available wavelength is only one in number, the supporting apparatus 4 allocates this wavelength to a path which is an object of design, and if the available wavelengths are two or more in number, the supporting apparatus 4 allocates, of the two or more wavelengths, the wavelength having the lowest transmission capability (for example, the wavelength most remote from the center of the band, or the shortest wavelength) thereto (allocation wavelength determination: step S3).

That is, the wavelength having the highest transmission capability and having the longest transmission distance limit is left for a critical case, such as “only this wavelength can establish a path”. Incidentally, as the factors of the wavelength dependency of the transmission distance limit, when the OSNR has a larger influence than the chromatic dispersion, it is preferable to employ the allocation of the shortest wavelength and, vice versa, it is preferable to use the allocation of the wavelength most remote from the center of the band.

In addition, the supporting apparatus 4 confirms whether or not all the requested path designs (wavelength allocations) come to an end (step S4) and, if they come to an end, terminates the processing (YES route of step S4). On the other hand, if a non-designed path remains, the processing in the aforesaid step S1 and subsequent steps are again conducted with respect to this path (NO route of step S4).

In a case in which the decision result in the step S2 shows the absence of a wavelength enabling the transmission from the starting node to the destination node without conducting the electrical signal regeneration, the supporting apparatus 4 confirms, on the basis of the aforesaid existing apparatus disposition information, whether or not a site, which permits the disposition of the electrical signal regenerator 113 (123) (optical repeater having it), exists in the middle of the path which is an object of design (step S5 through NO route of step S2). In most cases, whether the disposition of the electrical signal regenerator is feasible or not depends upon the floor area for the disposition in an office, the power supply capability and others.

If the confirmation result indicates the absence of the site permitting the disposition, the supporting apparatus 4 notifies a disposition impossibility error to the NMS 3 (or an operator) (NO route of step S5). On the other hand, if the confirmation result indicates the presence of the site permitting the disposition, the supporting apparatus 4 disposes the electrical signal regenerator 113 (123) in the node located in a site most remote from the starting node. Moreover, the supporting apparatus 4 divides the original design object path into two independent paths in this site (node) (step S6 through YES route of step S5) to carry out the processing of the aforesaid step S1 and subsequent steps on each of the divided paths as a new design object path.

That is, the calculation unit 42 conducts the processing from the YES route of the step S5 to the step S6, thereby fulfilling the function as a recommendation path dividing unit 424 to, in a case in which an idle wavelength which satisfies the transmission over the total optics transmission distance of the recommendation path is absent among the available wavelengths, divide the recommendation path into a plurality of optical transmission sections by means of the disposition of the electrical signal regenerators 113 (123).

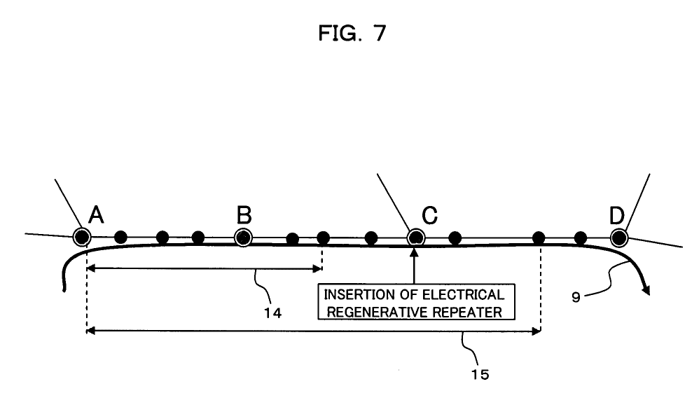

For example, as shown in FIG. 7, let it be assumed that a path 9 of starting node A→node B→node C→destination node D is a path which is an object of design and, of the available wavelengths, the transmission distance limit in the case of the wavelength having the lowest transmission capability is a distance indicated by the reference numeral 14 while the transmission distance limit for the wavelength having the highest transmission capability is a distance indicated by numeral 15 and the sites (nodes) which permit the disposition of the electrical signal regenerator 113 (123) are A, B, C and D while the sites which inhibit the disposition of the electrical signal regenerator 113 (123) are portions indicated by black circles in FIG. 7.

In this case, since the lights with the above-mentioned wavelengths cannot go through the path 9 from the starting node A to the destination node D without conducting the electrical signal regeneration, this path 9 is divided into the two transmission sections: the transmission section AC between the nodes A and C and the transmission section CD between the nodes C and D, and the wavelength having a higher transmission capability is allocated to the path of the section AC having the longer transmission distance.

Moreover, with respect to the section CD having the shorter transmission distance after the division, if there exists an idle wavelength which can pass through the section CD without conducting the electrical signal regeneration, a wavelength having a transmission capability as low as possible is allocated to the section CD. If absent, as in the above-mentioned case, the section CD is further divided with reference to the side which permits the disposition of the electrical signal regenerator 113 (123), and the wavelength having a higher transmission capability is allocated to one section having a longer transmission distance.

The employment of this algorithm can realize the high-efficiency wavelength allocation such that, as mentioned above with reference to FIG. 5, a wavelength having a higher transmission capability is allocated to a path having a longer total optics transmission distance while a wavelength having a lower transmission capability is assigned to a path having a shorter total optics transmission distance. Therefore, in comparison with the case in which the wavelength allocation is made without taking the wavelength dependency of the transmission characteristic into consideration, the number of electrical signal regenerators 113 (123) required for a path in the network 1 is reducible, and the cost of the entire network 1 is considerably reducible.

Meanwhile, in a case in which, as mentioned above, the electrical signal regenerator 113 (123) is required to be halfway disposed with respect to one path, a more efficient wavelength allocation is realizable by utilizing the wavelength conversion function positively.

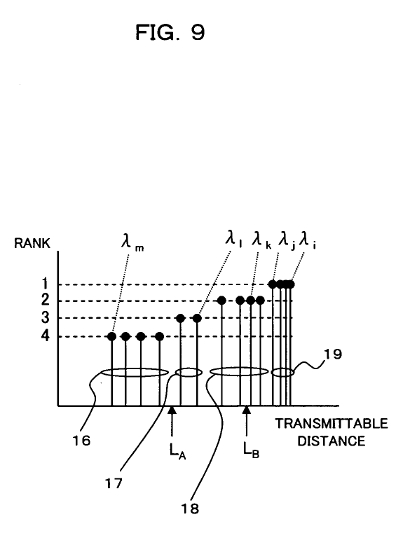

That is, for example, as shown in FIG. 9, the supporting apparatus 4 previously acquires the transmission capability (transmittable distance) of each wavelength in a WDM signal band on the basis of the aforesaid fiber information or the like according to calculations or the like and classifies the transmission capabilities of the respective wavelengths acquired. Concretely, the classification is made such that longer wavelengths are set to have a higher rank order or an equal rank order (in a case in which the transmission capability of each wavelength is determined predominantly by OSNR with wavelength dependency), or such that the wavelengths are set to have a higher rank order or an equal rank order as they approach (closer to) the reference wavelength (for example, central wavelength) defined in a WDM signal band (in a case in which the transmission capability of each wavelength is determined predominantly by the chromatic dispersion).

In this case, it is preferable that a middle order class is allocated to the median of the distribution of the initial total optics transmission distance of a network, and that the wavelength allocation is made so that the wavelength utilization factors of the respective classes become approximately even. This enables an extremely flexible operation with respect to the fluctuation or increase in network traffic.

In FIG. 9, as one example of the classification, a wavelength group having a transmission capability equivalent to a light with a wavelength λₘ. (which is not transmittable over a total optics transmission distance L_{A}) is set at a wavelength group 16 taking fourth place in class rank (wavelength class), a wavelength group having a transmission capability equivalent to a light with a wavelength λ₁ (which is transmittable over a total optics transmission distance L_{A} but not transmittable by a total optics transmission distance L_{B}) is set at a wavelength group 17 taking third place in class rank, a wavelength group having a transmission capability equivalent to lights with wavelengths λⱼ and λᵢ (which is transmittable over a total optics transmission distance L_{B}) is set at a wavelength group 19 taking first place in class rank, and a wavelength group including a wavelength λₖ having a transmission capability between the first place in class rank and the third place in class rank is set at a wavelength group 18 taking second place in class rank. This classification result (wavelength class information) is stored in a given storage medium (not shown) such as a memory provided in the supporting apparatus 4.

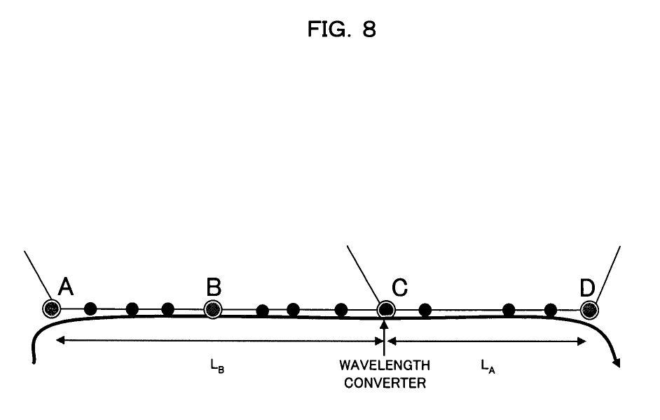

In addition, for example, in a case in which the electrical signal regenerator 113 (123) is installed in the node C as shown in FIG. 8, the total optics transmission distance L_{B} of the section AC before the wavelength conversion in this node C is longer than the total optics transmission distance L_{A} after the wavelength conversion in this node C, and for the optical transmission over the total optics transmission distance L_{A}, there is a need to use a wavelength pertaining to the wavelength groups 18 and 19 taking the third place in class rank or a higher place, and for the optical transmission over the total optics transmission distance L_{B}, there is a need to use a wavelength pertaining to the wavelength group 19 taking a place equal to or higher than the second place in class rank (however, in this case, even if pertaining to the wavelength group 18 taking the second place in class rank, same wavelengths are not transmittable).

For example, in a case in which a wavelength (for example, wavelength λₖ) taking the second place in class rank is allocated to the total optics transmission distance L_{B} of the transmission section AC, the transmission also becomes feasible in a manner such that a wavelength (for example, wavelength λⱼ) pertaining to the first place in class rank is allocated to the total optics transmission distance L_{A} of the transmission section CD and the wavelength conversion of the wavelength λₖ→the wavelength λⱼ is made in the node C. However, this results in the wasteful use of the wavelength taking the first place in class rank (in the case of the absence other than it, no choice but to use this wavelength).

In a case in which the utilization (operation) rate is low at the beginning of the introduction of the apparatus, for achieving the efficient wavelength allocation, in most cases, it is considered that the class rank of the allocation wavelength for the shorter total optics transmission distance L_{A} can be lower than or equal to the class rank of the allocation wavelength for the longer total optics transmission distance L_{B}. Conversely, if the total optics transmission distance L_{A} is longer than the total optics transmission distance L_{B}, with respect to a wavelength to be used, the class rank of the allocation wavelength for the total optics transmission distance L_{A} is higher than or equal to the class rank of the allocation wavelength for the total optics transmission distance L_{B}.

Accordingly, in a case in which the total optics transmission distance L_{A} of the optical transmission section CD after the electrical regenerative relay in the site C equipped with the electrical signal regenerator 113 (123) is longer than the total optics transmission distance L_{B} of the optical transmission section AC before the electrical regenerative relay, the supporting apparatus 4 according to this embodiment allocates, as a wavelength of an optical signal after the wavelength conversion, a wavelength pertaining to a class rank equal to or higher than a class rank to which a wavelength before the wavelength conversion in the site C pertains, and if the total optics transmission distance L_{A} of the optical transmission section CD after the electrical regenerative relay in the site C is shorter than the total optics transmission distance L_{B} of the optical transmission section AC before the electrical regenerative relay, the supporting apparatus 4 allocates, as a wavelength of an optical signal after the wavelength conversion, a wavelength pertaining to a class rank equal to or lower than a class rank to which a wavelength before the wavelength conversion in the site C pertains.

Thus, looking at the node 11, 13 (electrical signal regenerator 113, 123) serving as an optical repeater provided in the site C, the node 11, 13 has a function as a wavelength converter to selectively carry out the wavelength conversion on an optical signal which is an object of the electrical regenerative relay and further to convert the optical signal, which is an object of the wavelength conversion, into a wavelength pertaining to, of the wavelength groups classified according to the transmission capability as described above, one of a class rank equal to the class rank, to which the wavelength before the wavelength conversion pertains, or a class rank different therefrom which is to be selected on the basis of a difference in total optics transmission distance between before and after the electrical regenerative relay.

As described above, a hierarchy (data structure) of “wavelength rank order (classification)” is provided between the transmission distance and the allocation wavelength and, when the total optics transmission distance after the electrical signal regeneration is longer (shorter) than the total optics transmission distance before the electrical signal regeneration, the wavelength conversion is made so that the class rank becomes higher (lower) than before the conversion or is kept intact. Therefore, a flexible operation is conducted according to an operating state (in the case of a large or small number of long-distance total optics transmission sections, and in the case of variation of the number thereof) of the network 1, which enables the realization of the efficient network operation.

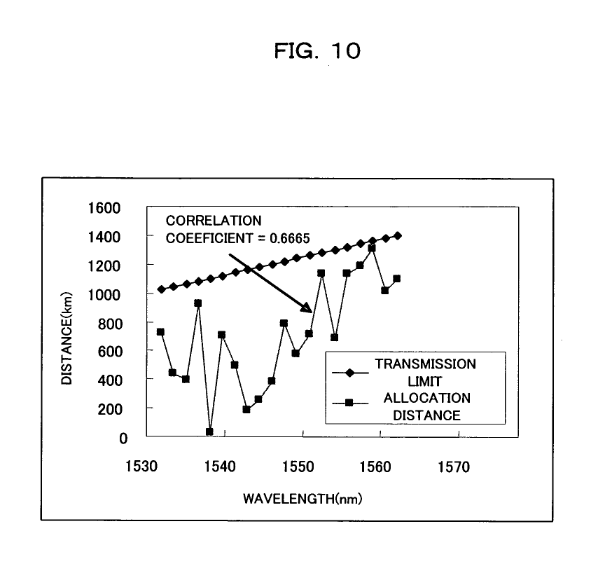

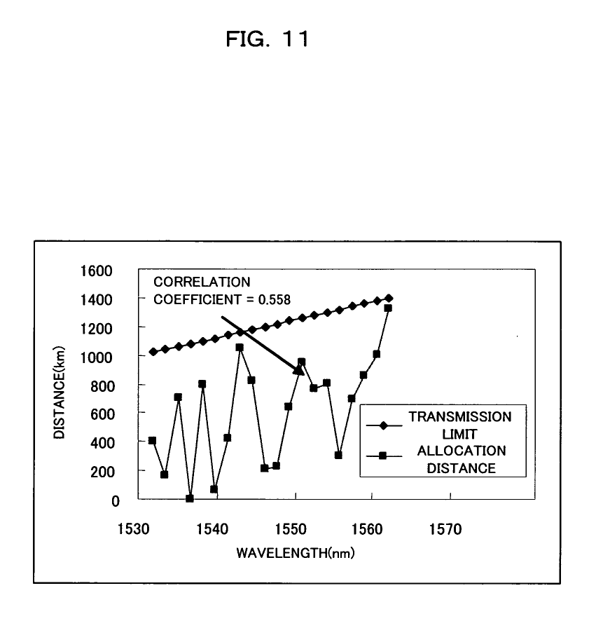

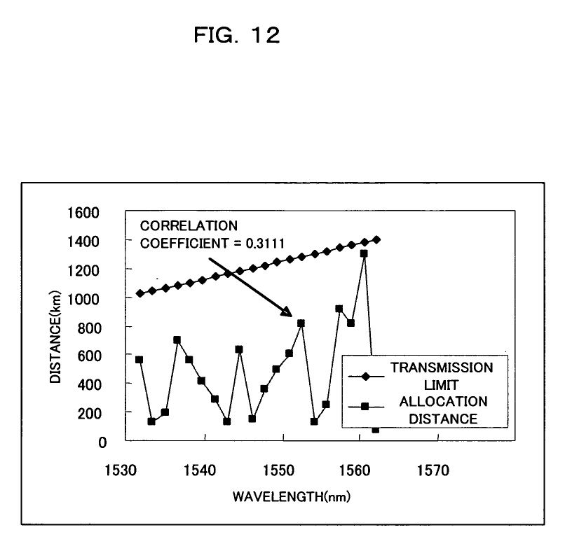

Meanwhile, when the wavelength allocation is made as described above, since a specific relationship exists between the wavelength transmission capability and the wavelength value, a correlation arises between the path total optics transmission distance and the allocation wavelength. For example, in a case in which the transmission distance limit of each wavelength is determined predominantly by the wavelength dependency OSNR, if the relationship between the distance of one transmission section and the wavelength allocated to this transmission section according to transmission capability indicates the result shown in FIG. 10, 11 or 12, when the correlation coefficient between the total optics transmission distance (xᵢ) and the allocation wavelength (yᵢ) in each case is obtained according to the following equation (1), the respective correlation coefficients Rxy for the wavelength allocation results shown in FIGS. 10, 11 and 12 become a positive value (“0.6665”, “0.558, “0.3111”).

$$Rxy = \frac{\sum ( {x}_{i} - {m}_{x} ) \cdot ( {y}_{i} - {m}_{y} )}{\sqrt{\sum {( {x}_{i} - {m}_{x} )}^{2}} \cdot \sqrt{\sum {( {y}_{i} - {m}_{y} )}^{2}}} \qquad ( 1 )$$

where, in the above-mentioned equation (1), mₓ designates an average value of xᵢ and m_{y} designates an average value of yᵢ.

The correlation calculation according to this equation (1) is made in the calculation unit 42 of the supporting apparatus 4. That is, the calculation unit 42 functions as a correlation calculating unit 423 (see FIG. 4) to obtain a coefficient of correlation between the total optics transmission distance of an optical transmission section of a recommendation path and a wavelength to be allocated to this optical transmission section.

In other words, the above-mentioned wavelength allocation in the supporting apparatus 4 (calculation unit 42) is equivalent to that, when 50% or more of the maximum number of wavelengths available in the network 1 are put to use, the aforesaid wavelength allocation is made so that the correlation coefficient obtained in the aforesaid correlation calculating unit 423 becomes a positive value.

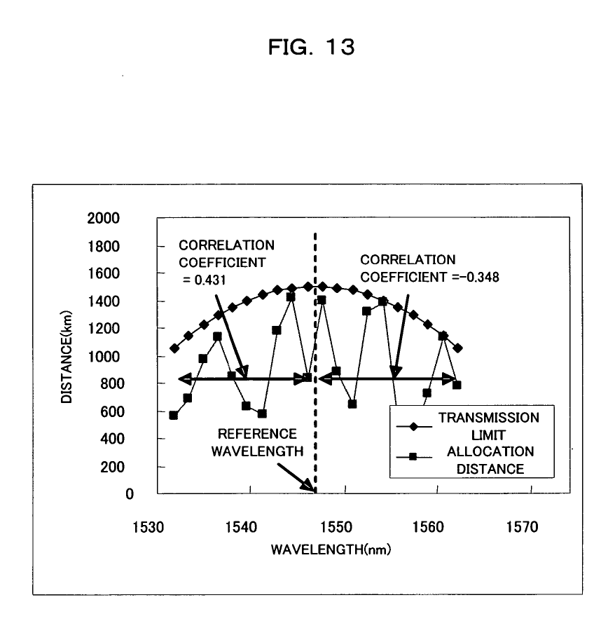

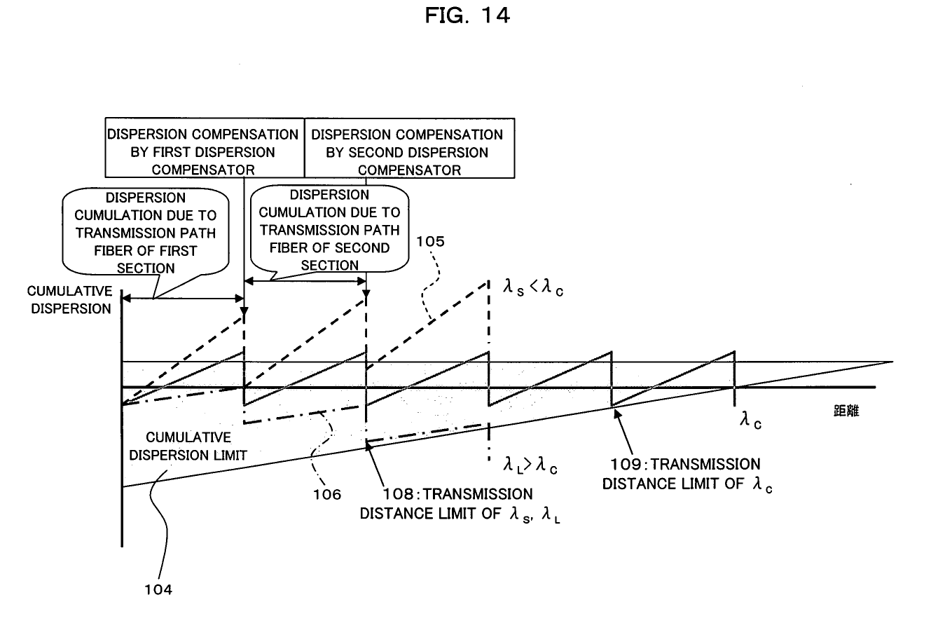

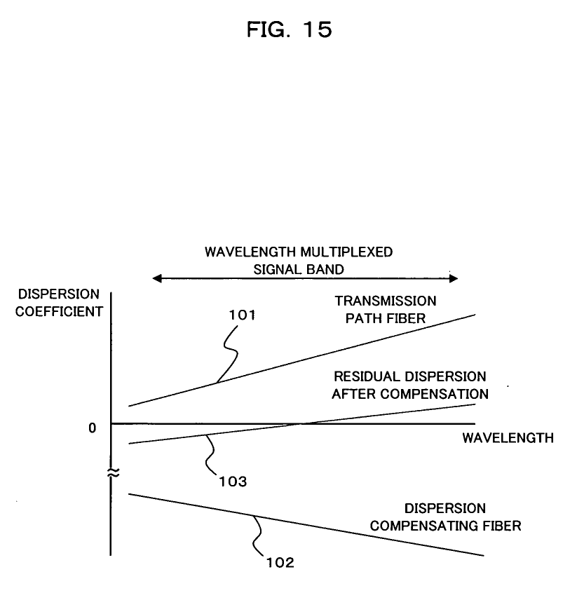

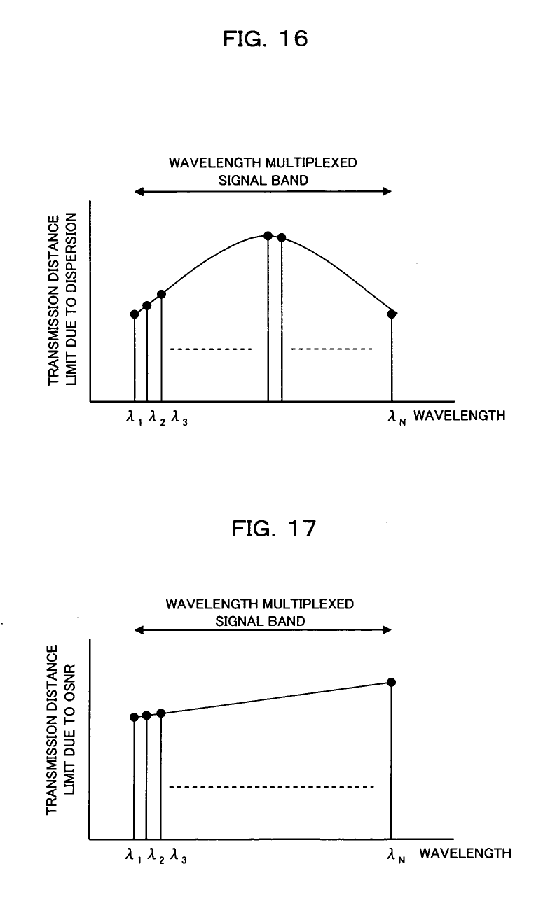

On the other hand, in a case in which the transmission distance limit of each wavelength is determined predominantly by chromatic dispersion, the wavelength allocation in the supporting apparatus 4 signifies that the relationship between the distance of one transmission section and the wavelength allocated to this transmission section according to transmission capability is the relationship shown in FIG. 13. Also in this case, when the correlation coefficient is calculated according to the above-mentioned equation (1) in the correlation calculating unit 423, in a state where a central wavelength of a WDM signal band is a reference wavelength, a positive value (“0.431”) is obtained on a short wavelength side and a negative value (“−0.348”) on a long wavelength side.

In other words, in this case, the supporting apparatus (calculation unit 42) carries out the wavelength allocation so that, when 75% or more of the maximum number of wavelengths available in a WDM signal band are put to use, the correlation coefficient obtained by the correlation coefficient calculating unit 423 becomes positive in a shorter wavelength range with respect to a given reference wavelength and becomes negative in a longer wavelength range relative thereto.

From the above, the photonic network system according to this embodiment can conduct the operation so that, of the signal light wavelength groups used in the network 1, the average value of the total optics transmission distances of the wavelength path groups in a case in which the transmission is made through the use of the shortest wavelength becomes smaller than the average value of the total optics transmission distances of the wavelength path groups when the transmission is made using a median wavelength of the signal light wavelength groups used in the network 1.

As described above, the present invention can allocate a wavelength having a transmission capability suitable for the total optics transmission distance of a transmission section in a photonic network, the number of optical repeaters to be disposed, each of which has an electrical signal regeneration function in the photonic network, is considerably reducible, which enables the reduction of the number of devices, dissipation power, installation area and others. Therefore, it is considered that the present invention is extremely useful in the field of optical communication technology.

1. An optical repeating apparatus comprising:
a regenerative repeating unit for carrying out electrical regenerative relay selectively on a plurality of inputted optical signals; and
a wavelength converter for carrying out wavelength conversion selectively on the optical signal which is an object of said electrical regenerative relay in said regenerative repeating unit and for converting the optical signal, which is an object of said wavelength conversion, into a wavelength pertaining to, of wavelength classes obtained by classification according to transmission capability, one of a wavelength class equal to a wavelength class, to which a wavelength before said wavelength conversion pertains, and a wavelength class different therefrom which is to be selected on the basis of a difference in total optics transmission distance between before and after said electrical regenerative relay.

2. The optical repeating apparatus according to claim 1, wherein said wavelength converter is configured so as to, in a case in which the total optics transmission distance after said electrical regenerative relay is longer than the total optics transmission distance before said electrical regenerative relay, convert said optical signal which is an object of said wavelength conversion into a wavelength pertaining to a wavelength class equal to the wavelength class to which the wavelength before said wavelength conversion pertains or a wavelength class higher than the wavelength class to which the wavelength before said wavelength conversion pertains.

3. The optical repeating apparatus according to claim 1, wherein said wavelength converter is configured so as to, in a case in which the total optics transmission distance after said electrical regenerative relay is shorter than the total optics transmission distance before said electrical regenerative relay, convert said optical signal which is an object of said wavelength conversion into a wavelength pertaining to a wavelength class equal to a wavelength class to which a wavelength before said wavelength conversion pertains or a wavelength class lower than the wavelength class to which the wavelength before said wavelength conversion pertains.

4. The optical repeating apparatus according to claim 1, wherein said wavelength classes are classified so as to have a higher rank order or have an equal rank order as the wavelengths become longer.

5. The optical repeating apparatus according to claim 1, wherein said wavelength classes are classified so as to have a higher rank order or to have an equal rank order as the wavelengths are closer to a reference wavelength defined in a transmission wavelength band of said plurality of inputted optical signals.

6. An optical network system comprising:
an optical repeating apparatus, wherein said optical
repeating apparatus comprises
a regenerative repeating unit for carrying out electrical regenerative relay selectively on a plurality of inputted optical signals; and
a wavelength converter for carrying out wavelength conversion selectively on the optical signal which is an object of said electrical regenerative relay in said regenerative repeating unit and for converting the optical signal, which is an object of said wavelength conversion, into a wavelength pertaining to, of wavelength classes obtained by classification according to transmission capability, one of a wavelength class equal to a wavelength class, to which a wavelength before said wavelength conversion pertains, and a wavelength class different therefrom which is to be selected on the basis of a difference in total optics transmission distance between before and after said electrical regenerative relay.

7. An optical network design supporting apparatus for, which is made to selectively dispose one or more optical repeating apparatuses each having a function for carrying out electrical regenerative relay selectively on a plurality of inputted optical signals and a function for carrying out wavelength conversion selectively on said optical signal which is an object of said electrical regenerative relay, said design supporting apparatus comprising:
storage means storing wavelength class information on wavelength classes obtained by classification of a plurality of wavelengths available in said optical network according to transmission capability of said wavelengths;
recommendation transmission path dividing means for, in a case in which an idle wavelength which satisfies optical transmission over a total optics transmission distance of a recommendation optical transmission path in said optical network for a traffic demand from the external does not exist among the available wavelengths, dividing said recommendation optical transmission path into a plurality of optical transmission sections by the disposition of said optical repeating apparatus; and
wavelength allocating means for allocating a wavelength pertaining to, of said wavelength classes obtained by classification based on said wavelength class information in said storage means, one of a wavelength class equal to a wavelength class, to which a wavelength before said wavelength conversion of said optical signal pertains, and a wavelength class different therefrom which is to be selected on the basis of a difference in total optics transmission distance of said optical transmission section between before and after said electrical regenerative relay.

8. The optical network design supporting apparatus according to claim 7, wherein said wavelength allocating means is configured so as to, in a case in which the total optics transmission distance of said optical transmission section after said electrical regenerative relay in said optical repeating apparatus is longer than the total optics transmission distance of said optical transmission section before said electrical regenerative relay, allocate a wavelength pertaining to a wavelength class equal to the wavelength class to which the wavelength before said wavelength conversion in said optical repeating apparatus pertains or a wavelength class higher than the wavelength class to which the wavelength before said wavelength conversion pertains, while, in a case in which the total optics transmission distance of said optical transmission section after said electrical regenerative relay in said optical repeating apparatus is shorter than the total optics transmission distance of said optical transmission section before said electrical regenerative relay, allocate a wavelength pertaining to a wavelength class equal to the wavelength class to which the wavelength before said wavelength conversion in said optical repeating apparatus pertains or a wavelength class lower than the wavelength class to which the wavelength before said wavelength conversion pertains.

9. An optical network design supporting method, which is for selectively disposing one or more optical repeating apparatuses each having a function to carry out electrical regenerative relay selectively on a plurality of inputted optical signals and a function to carry out wavelength conversion selectively on said optical signal which is an object of said electrical regenerative relay, said design supporting method comprising the steps of:
storing, in storage means, wavelength class information on wavelength classes obtained by classification of a plurality of wavelengths allocable in said optical network according to transmission capability of said wavelengths;
in a case in which an idle wavelength which satisfies optical transmission over a total optics transmission distance of a recommendation optical transmission path in said optical network for a traffic demand from the external does not exist among the allocable wavelengths of said wavelength class information in said storage means, dividing said recommendation optical transmission path into a plurality of optical transmission sections by the disposition of said optical repeating apparatus; and
with respect to said optical signal which is an object of said wavelength conversion in said optical repeating apparatus, allocating a wavelength pertaining to, of wavelength classes obtained by classification based on said wavelength class information in said storage means, one of a wavelength class equal to a wavelength class, to which a wavelength before said wavelength conversion of said optical signal pertains, and a wavelength class different therefrom which is to be selected on the basis of a difference in total optics transmission distance of the divided optical transmission sections between before and after said electrical regenerative relay.

10. The optical network design supporting method according to claim 9, wherein a comparison is made in terms of the total optics transmission distances of the divided optical transmission sections and, in a case in which the total optics transmission distance of said optical transmission section after said electrical regenerative relay in said optical repeating apparatus is longer than the total optics transmission distance of said optical transmission section before said electrical regenerative relay, a wavelength pertaining to a wavelength class equal to the wavelength class to which the wavelength before said wavelength conversion in said optical repeating apparatus pertains or a wavelength class higher than the wavelength class to which the wavelength before said wavelength conversion pertains is allocated as a wavelength of said optical signal after said wavelength conversion and, in a case in which the total optics transmission distance of said optical transmission section after said electrical regenerative relay in said optical repeating apparatus is shorter than the total optics transmission distance of the optical transmission section before said electrical regenerative relay, a wavelength pertaining to a wavelength class equal to the wavelength class to which the wavelength before said wavelength conversion in said optical repeating apparatus pertains or a wavelength class lower than the wavelength class to which the wavelength before said wavelength conversion pertains is allocated as said wavelength of said optical signal after said wavelength conversion.

11. An optical network design supporting apparatus, comprising:
transmission capability calculating means for calculating a transmission capability for each of a plurality of wavelengths available in said optical network; and
wavelength allocating means for allocating, to a recommendation optical transmission path in said optical network for a traffic demand from the external, a wavelength having a transmission capability corresponding to a total optics transmission distance of said recommendation optical transmission path on the basis of a result of the calculation in said transmission capability calculating means.

12. An optical network design supporting method, comprising the steps of:
calculating a transmission capability for each of a plurality of wavelengths available in said optical network; and
allocating, to a recommendation optical transmission path in said optical network for a traffic demand from the external, a wavelength having a transmission capability corresponding to a total optics transmission distance of said recommendation optical transmission path on the basis of a result of the calculation.
